(19) United States
(12) Patent Application Publication
(10) Pub. No.: US 2015/0224804 A1
(43) Pub. Date: Aug. 13, 2015

(54) SURFACE TREATMENT METHOD FOR IMAGE

(71) Applicant: CANON KABUSHIKI KAISHA, Tokyo (JP)

(72) Inventors: Hiroshi Inomata, Yokohama-shi (JP); Hirofumi Ota, Yokohama-shi (JP)

(21) Appl. No.: 14/618,286

(22) Filed: Feb. 10, 2015

(30) Foreign Application Priority Data
Feb. 12, 2014 (JP) 2014-024067

(51) Int. Cl. B41M 7/00

(52) U.S. Cl. CPC B41M 7/0045; B41M 2205/40

(57) ABSTRACT

A surface treatment method for an image includes a varnishing process of applying an ultraviolet curing varnish to a surface of an image containing wax and an ultraviolet irradiation process of irradiating the applied ultraviolet curing varnish with ultraviolet light. A heating process of heating the surface of the image is performed between the varnishing process and the ultraviolet irradiation process.

### BACKGROUND

1. Field of the Invention

The present disclosure relates to a surface treatment method for an image using an ultraviolet curing varnish.

2. Description of the Related Art

An electrophotographic process or an inkjet process is sometimes used to form an image on a recording medium, such as coated board paper. Images (compositions of images) generally contain a coloring material, and in addition, sometimes wax. Adding wax to images formed by an electrophotographic process can prevent a coloring material from adhering to a fixing roller and improve the glossiness of the images.

Meanwhile, the surface of a formed image is sometimes coated with an ultraviolet curing varnish to enhance the quality appearance and abrasion resistance of the image. However, in the case of an image containing wax, the varnish is repelled on the surface of the image, thus making it difficult to apply varnish uniformly.

To solve the above problem, Japanese Patent Laid-Open No. 2011-57442 discloses a plasma surface treatment method for an image before the image is coated with an ultraviolet curing varnish. This method can reduce the repellence of an ultraviolet curing varnish on the surface of an image, allowing the ultraviolet curing varnish to be uniformly applied.

### SUMMARY

The present disclosure provides a surface treatment method for an image, including a varnishing process of applying an ultraviolet curing varnish to a surface of an image containing wax; and an ultraviolet irradiation process of irradiating the applied ultraviolet curing varnish with ultraviolet light. A heating process of heating the surface of the image is performed between the varnishing process and the ultraviolet irradiation process.

Further features of the present invention will become apparent from the following description of exemplary embodiments with reference to the attached drawings.

### BRIEF DESCRIPTION OF THE DRAWINGS

FIG. 1 is a perspective view of an example of a surface treatment apparatus that performs a surface treatment method for an image.

FIG. 2 is a cross-sectional view of the example of the surface treatment apparatus that performs a surface treatment method for an image.

### DESCRIPTION OF THE EMBODIMENTS

A study by the inventors has found that the use of the method disclosed in Japanese Patent Laid-Open No. 2011-57442 sometimes causes an ultraviolet curing varnish to flake off the surface of an image after the ultraviolet curing varnish is cured by ultraviolet irradiation.

The present disclosure provides a surface treatment method for an image containing wax. The method includes applying an ultraviolet curing varnish to a surface of the image. The ultraviolet curing varnish hardly flakes off the surface of the image even after cured under ultraviolet irradiation.

An embodiment disclosed herein will be described hereinbelow with reference to the drawings.

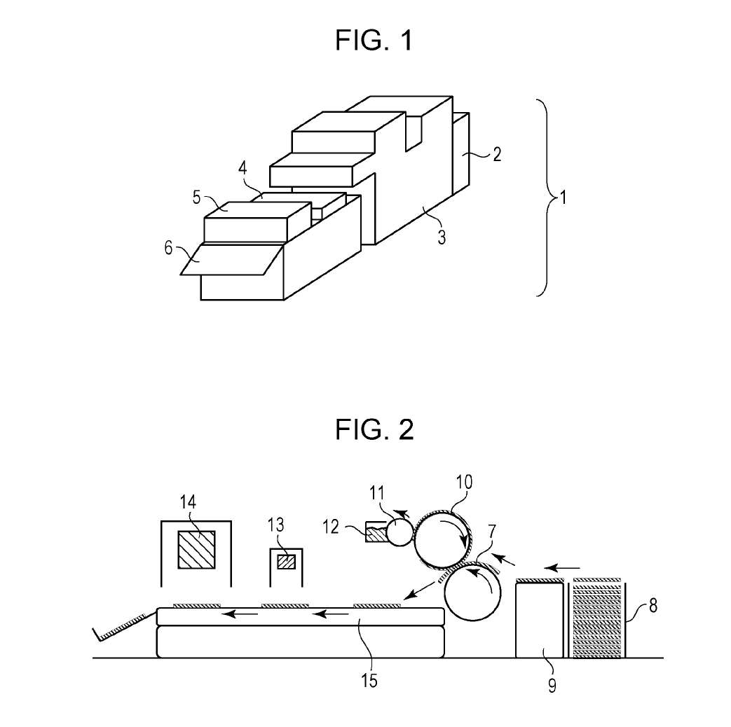

FIG. 1 is a perspective view of the whole of a surface treatment apparatus 1 that performs a surface treatment method for an image according to an embodiment of the present invention. The surface treatment apparatus 1 includes a stocker 2 that stocks recording media, such as paper on which an image is formed. Each recording medium moves from the stocker 2 to a varnishing machine 3, where the surface of the image is coated with an ultraviolet curing varnish. Subsequently, the recording medium passes through an IR unit 4 including an IR lamp, where the surface of the image is heated. After the heating, the recording medium is conveyed to an ultraviolet irradiator 5, where the ultraviolet curing varnish applied on the surface of the image is irradiated with ultraviolet light. This causes the ultraviolet curing varnish to be cured on the surface of the image. Thereafter, the recording medium is discharged to a stock section 6.

FIG. 2 is a diagram illustrating the surface treatment apparatus 1 illustrated in FIG. 1 in more detail using a cross-sectional view of the apparatus 1. A recording medium 7 on which an image is formed is fed from a stocker 8 one by one, and the position of the recording medium 7 is corrected at a position correction station 9 using the corners of the recording medium 7. Subsequently, the recording medium 7 moves to a roller of a flexographic plate 10, with which the surface of the image is coated with an ultraviolet curing varnish 12 (a varnishing process). Such a flexographic varnishing machine transfers the ultraviolet curing varnish 12 adherent to an anilox roller 11 to the flexographic plate 10 and then transfers the ultraviolet curing varnish 12 from the flexographic plate 10 to the recording medium 7. The surface of the image is coated with the ultraviolet curing varnish 12 using such a varnishing unit. The anilox roller 11 has a role in transferring a fixed amount of the ultraviolet curing varnish 12 to the flexographic plate 10. The anilox roller 11 has many pores in the surface thereof. The thickness of the ultraviolet curing varnish 12 to be applied to the recording medium 7 depends on the size of the pores. The flexographic application allows the flexographic plate 10 to be easily replaced depending on the application target and can support various models. It is noted that the varnishing method is provided for illustrative purpose only, and is not intended to limit the present invention; for example, a simple vanishing method may be used.

After the varnishing process, the recording medium 7 is conveyed to below an IR lamp 13 of the IR unit 4 and passes below the IR lamp 13 serving as a heating unit. At that time, the surface of the image is heated (a heating process). The IR lamp 13 can uniformly heat the image on the recording medium and the ultraviolet curing varnish 12. It is noted that the IR lamp 13 for use in heating is not intended to limit the present invention; for example, a halogen lamp may be used. For heating, the temperature of the IR lamp 13 is preferably at 150° C. or higher, and more preferably, at 200° C. or higher. Furthermore, the temperature is preferably at 400° C. or lower, and more preferably, 300° C. or lower.

After the heating process, the recording medium 7 is conveyed to below an ultraviolet lamp 14 serving as an ultraviolet irradiation unit with a conveyor belt 15. The ultraviolet curing varnish 12 applied to the surface of the image is irradiated with ultraviolet light below the ultraviolet lamp 14 (an ultraviolet irradiation process). The ultraviolet irradiation causes the ultraviolet curing varnish 12 to be cured. Examples of the ultraviolet lamp 14 include a mercury lamp, a metal halide lamp, and an LED lamp.

An image formed on the recording medium 7 in an embodiment of the present invention contains wax. In an embodiment of the present invention, the heating process of heating the surface of an image is provided between the varnishing process and the ultraviolet irradiation process, as described above. When the surface of an image is heated, the image and the ultraviolet curing varnish 12 are also heated. This reduces the tendency of the ultraviolet curing varnish 12 to flake off the surface of the image even after it is cured under ultraviolent irradiation.

It is noted that a recording medium on which an image is formed is not particularly limited. For example, coated board paper and plain paper may be used.

In the heating process, the surface of an image is preferably heated at 35° C. or higher from the viewpoint of enhancing the flaking resistance. Heating the surface of an image at 35° C. or higher can translate into heating the surface of an image to 35° C. or higher. More preferably, the surface of an image may be heated at 40° C. or higher, and still more preferably, at 45° C. or higher. Preferably, the surface of an image may be heated at 60° C. or lower, and more preferably, at 50° C. or lower from the viewpoint of reducing the whitening phenomenon of the varnish. From the viewpoint of enhancing the flaking resistance and reducing the whitening phenomenon, the heating temperature may be determined in view of the melting point of the composition of the image. More specifically, the surface of the image may be heated at X±10° C., where X° C. is the melting point of the composition of the image.

In an embodiment of the present invention, the heating process is performed before the surface of an image is irradiated with ultraviolet light. The heating process is preferably performed within one minute before ultraviolet irradiation. More preferably, the heating process is performed within 30 seconds before, and still more preferably, 10 seconds before. Preferably, the heating process is performed after the recording medium is output from the stocker from the viewpoint of manufacture. Preferably, the surface of an image is heated so that it increases in temperature by 10° C. or more after the heating. More preferably, the surface of the image is heated so that it increases in temperature by 15° C. or more.

### EXAMPLES

Concepts disclosed herein will be described in more detail using examples.

First, coated board paper (Trade name: Maricoat, manufactured by Hokuetsu Kishu Paper Co, Ltd.) was prepared as recording media 7, on which images were formed using an electrophotographic recording apparatus (Trade name: imagePRESS C7010VPS, manufactured by CANON KABUSHIKIKAISHA). The images were formed using four colors (yellow, magenta, cyan, and black) of toners (Trade name: NPG-34, manufactured by CANON KABUSHIKIKAISHA). These toners each contain a coloring material and wax. For example, a magenta toner contains pigment as a coloring material and solid paraffin as wax, as well as polyester resin and amorphous silica. The surfaces of the formed images have water repellency.

Subsequently, the recording media 7 on which images are formed were stocked in the stocker 8 shown in FIG. 2. Thereafter, the recording media 7 were each transferred to the position correction station 9, where the position of the recording medium 7 was corrected, and was moved to the roller of the flexographic plate 10, where the surface of the image was coated with the ultraviolet curing varnish 12 using the flexographic plate 10. As the ultraviolet curing varnish 12, a varnish containing acrylic resin as the main ingredient was used. The flexographic plate 10 is a relief printing plate, only protruding portions of which was varnished, and the ultraviolet curing varnish 12 was applied to the surface of the image on the recording medium 7. The thickness of the ultraviolet curing varnish 12 to be formed on the surface of the image was set to 5 μm by adjusting the pores of the anilox roller 11.

After the ultraviolet curing varnish 12 was applied onto the surface of the image on the recording medium 7 using the flexographic plate 10, the recording medium 7 was moved onto the conveyor belt 15. The moving speed of the conveyor belt 15 was set at 20 m/min. Subsequently, the recording medium 7 was moved to below the IR lamp 13, with which the image and the applied ultraviolet curing varnish 12 were heated. The IR lamp 13 was of a bar type with an output of 2 KW that generates infrared light with a wavelength that the toners can easily absorb. A plurality of IR lamps 13 each having an ON/OFF switch were used to provide a sufficient volume with which the output can be varied. During heating, the distance between the IR lamp 13 and the recording medium 7 was set at 120 mm. The heating temperature on the surface of the image was changed among Examples 1 to 7, as shown in Table 1. In Comparative Example 1, heating was not performed. The temperature of the surface of the image before heating was at 15° C. in all the examples.

Thereafter, the recording medium 7 was conveyed to below the ultraviolet lamp 14 with the conveyor belt 15, and the applied ultraviolet curing varnish 12 was irradiated with ultraviolet light. The recording medium 7 was moved from below the IR lamp 13 to below the ultraviolet lamp 14 in five seconds. The integrated quantity of ultraviolet light in the ultraviolet irradiation process was set to 100 mJ/cm². The image surface treatment process was performed in this way.

### Evaluation

The image after subjected to the surface treatment was evaluated with the following criteria.

### Adhesiveness

The recording medium 7 after subjected to the image surface treatment was undergone a cellophane tape test to evaluate the adhesiveness between the surface of the image and the ultraviolet curing varnish 12. The cellophane tape test was performed as follows: the surface of the recording medium 9 (the surface of the ultraviolet curing varnish 12 on the image) was covered with a cellophane tape, then the cellophane tape was peeled off, and a visual determination was made with the following criteria.

A: The ultraviolet curing varnish 12 adhering to the cellophane tape was detected.
B: The ultraviolet curing varnish 12 adhering to the cellophane tape was not detected.

### Whitening Phenomenon

A whitening phenomenon refers to a state in which the surface of an image after the ultraviolet curing varnish 12 was cured appears to be fogged, and the gloss of the surface of the image is reduced. We made a visual determination on the state of the surface of the treated image with the following criteria.

A: The surface of the image was not determined to be fogged, and the surface of the image was glossy.
B: The surface of the image was determined to be fogged.

TABLE 1

| | Heating | | |
|---|---|---|---|
| | temperature | | Whitening |
| | (° C.) | Adhesiveness | phenomenon |
| EXAMPLE 1 | 60 | A | B |
| EXAMPLE 2 | 55 | A | B |
| EXAMPLE 3 | 50 | A | B |
| EXAMPLE 4 | 45 | A | A |
| EXAMPLE 5 | 40 | A | A |
| EXAMPLE 6 | 35 | A | A |
| EXAMPLE 7 | 30 | B | A |
| COMPARATIVE | Not heated | B | A |
| EXAMPLE 1 | | | |

Table 1 shows that there is a significant difference in the adhesiveness between the surface of the image and the ultraviolet curing varnish 12 between a case where heating is performed before ultraviolet irradiation and a case where no heating is performed. In the case of heating, setting the heating temperature to 35° C. or higher will enhance the adhesiveness. The inventors guess the reason that the adhesiveness is enhanced by increasing the heating temperature as follows. The melting points of toners used in these examples were about 50° C., which is equal to the melting point of a general toner. Heating the toners to the vicinity of the temperature causes the toners and the wax contained in the toners to be softened, thus causing a condition in which the varnish before being cured and the wax easily mix. This enhances the adhesiveness between the varnish and the surface of the image.

The surface of an image in comparative example 1 was heated to 45° C. after ultraviolet irradiation, whereas the adhesiveness did not differ from the result in Table 1. This result shows that heating needs to be performed before ultraviolet irradiation.

Furthermore, Table 1 shows that the occurrence of the whitening phenomenon can be reduced by setting the heating temperature to 45° C. or lower. With a heating temperature of 50° C. or higher, the viscosity of the ultraviolet curing varnish 12 decreases, which would develop the surface roughness of the recording medium or the toners on the surface of the ultraviolet curing varnish 12, thus causing the image to appear to be fogged.

Subsequently, as a reference example, coated board paper (Trade name: Maricoat, manufactured by Hokuetsu Kishu Paper Co, Ltd.) was prepared as a recording medium, on which an image was formed using an electrophotographic recording apparatus (Trade name: DocuColor 8000 DigitalPress, manufactured by Fuji Xerox Co., Ltd.). An image was formed using dedicated color toners (yellow, magenta, cyan, and black) (Trade name: 6R1202, 6R1199, 6R1201, and 6R1200, manufactured by Fuji Xerox Co., Ltd.). These toners contain no wax.

For the reference example, the varnishing process and the ultraviolet irradiation process were performed without the heating process, as in comparative example 1, for which the same evaluation as that for comparative example 1 was performed. The results are shown in Table 2.

TABLE 2

| | Heating | | Whitening |
|---|---|---|---|
| | temperature (° C.) | Adhesiveness | phenomenon |
| REFERENCE | Not heated | A | A |
| EXAMPLE | | | |

Table 2 shows that there is no need to perform the heating process on an image containing no wax in the viewpoint of adhesiveness and the whitening phenomenon. In other words, the surface treatment method for an image according to an embodiment of the present invention has an effect on an image containing wax.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-024067, filed Feb. 12, 2014, which is hereby incorporated by reference herein in its entirety.

What is claimed is:

1. A surface treatment method for an image, comprising:
a varnishing process of applying an ultraviolet curing varnish to a surface of an image containing wax; and
an ultraviolet irradiation process of irradiating the applied ultraviolet curing varnish with ultraviolet light, wherein a heating process of heating the surface of the image is performed between the varnishing process and the ultraviolet irradiation process.

2. The surface treatment method for an image according to claim 1, wherein, in the heating process, the surface of the image is heated at a heating temperature of 35° C. or higher.

3. The surface treatment method for an image according to claim 1, wherein, in the heating process, the surface of the image is heated at a heating temperature of 40° C. or higher.

4. The surface treatment method for an image according to claim 1, wherein, in the heating process, the surface of the image is heated at a heating temperature of 45° C. or higher.

5. The surface treatment method for an image according to claim 1, wherein, in the heating process, the surface of the image is heated so as to be 60° C. or lower.

6. The surface treatment method for an image according to claim 1, wherein, in the heating process, the surface of the image is heated so as to be 50° C. or lower.

7. The surface treatment method for an image according to claim 1, wherein, in the heating process, the surface of the image is heated at X±10° C., where X° C. is a melting point of a composition of the image.

8. The surface treatment method for an image according to claim 1, wherein the wax is solid paraffin.

9. The surface treatment method for an image according to claim 1, wherein the heating is performed using an IR lamp.

10. The surface treatment method for an image according to claim 1, wherein the image contains toner.

11. The surface treatment method for an image according to claim 1, wherein the surface of the image is heated so as to increase by 15° C. or more by the heating process.

12. The surface treatment method for an image according to claim 1, wherein the heating process is performed within one minute before the ultraviolet irradiation process.

13. A surface treatment apparatus for an image, comprising:
a varnishing unit configured to apply an ultraviolet curing varnish to a surface of an image containing wax; and
an ultraviolet irradiation unit configured to irradiate the applied ultraviolet curing varnish with ultraviolet light, wherein
a heating unit configured to heat the surface of the image is provided between the application of the varnish with the varnishing unit and the ultraviolet irradiation with ultraviolet irradiation unit.

14. The surface treatment apparatus for an image according to claim 13, wherein the surface of the image is heated at a heating temperature of 35° C. or higher.

15. The surface treatment apparatus for an image according to claim 13, wherein the surface of the image is heated at a heating temperature of 40° C. or higher.

16. The surface treatment apparatus for an image according to claim 13, wherein the surface of the image is heated at a heating temperature of 45° C. or higher.

17. The surface treatment apparatus for an image according to claim 13, wherein the surface of the image is heated at a heating temperature of 50° C. or higher.

18. The surface treatment apparatus for an image according to claim 13, the surface of the image is heated at X±10° C. with the heating unit, where X° C. is a melting point of a composition of the image.

19. The surface treatment apparatus for an image according to claim 13, wherein the heating unit is an IR lamp.

20. The surface treatment apparatus for an image according to claim 13, wherein the surface of the image is heated so as to increase by 15° C. or more with the heating unit.
